(19) United States
(12) Patent Application Publication
(10) Pub. No.: US 2001/0049659 A1
(43) Pub. Date: Dec. 6, 2001

(54) Inserter billing system with electronic distribution

(75) Inventor: John K. Eckl, Brookfield, CT (US)

Correspondence Address: Pitney Bowes Inc., Michael J. Cummings, 35 Waterview Drive, Shelton, CT, 06484-8000, US

(73) Assignee: Pitney Bowes Incorporated, Stamford, CT

(21) Appl. No.: 09/903,500

(22) Filed: Jul. 12, 2001

Related U.S. Application Data
(63) Continuation of application No. 08/772,293, filed on Dec. 23, 1996.

(51) Int. Cl. G06F 17/60; G06F 15/173

(52) U.S. Cl. 705/40; 705/39; 709/238

(57) ABSTRACT

An inserting system for communicating information from a mailer to a recipient by means of a document or electronic transmission. The inserting system includes: a device for generating the information located at a mailer's site; an electronic information server operably connected to the information generating device for processing and routing the information; a printer operably connected to the server for printing the information on a substrate; an inserting system operably connected to the printer; a communications network operably connected to the server for transmitting the information electronically; and a recipient reception device for receiving the information from the communications network, wherein the server routes the information to the recipient reception device or to the printer.

### BACKGROUND OF THE INVENTION

The instant invention relates to envelope inserting equipment, and more particularly to such equipment which is utilized by production mailers to send bills or statements to their customers.

There are many businesses today which utilize envelope inserting apparatus to mail their customers bills or periodic statements. Envelope inserting apparatus is well known and essentially employs bursting apparatus and/or cutting devices, folding apparatus, feeders and conveying devices to assemble a collation of documents and feed the document collation to an inserting station where the collation is inserted into a waiting envelope. The envelope is then closed and sealed and printed with an appropriate amount of postage.

With the emergence of the “information superhighway”, many customers today prefer to receive their bills and statements in electronic form on their computers, such as through e-mail. The production mailers sending out the bills and statements can benefit from electronic transmission of bills and statements because delivery can be more timely and the cost of delivery can be significantly reduced relative to delivery of hard copy of bills and statements.

Accordingly, the instant invention provides a system for inserting apparatus which will enable production mailers using the inserting apparatus to offer their customers electronic copies of their bills and statements, and a mechanism with which to pay the bills as well.

### SUMMARY OF THE INVENTION

Thus, the instant invention provides an inserting system for communicating information from a mailer to a recipient by means of a document or electronic transmission. The inserting system includes: a device for generating the information located at a mailer's site; an electronic information server operably connected to the information generating device for processing and routing the information; a printer operably connected to the server for printing the information on a substrate; an inserting system operably connected to the printer; a communications network operably connected to the server for transmitting the information electronically; and a recipient reception device for receiving the information from the communications network, wherein the server routes the information to the recipient reception device or to the printer.

### DESCRIPTION OF THE DRAWINGS

FIG. 1 is a block diagram/system flow chart for the electronic distribution inserter system according to the instant invention.

### DETAILED DESCRIPTION OF THE PREFERRED EMBODIMENT

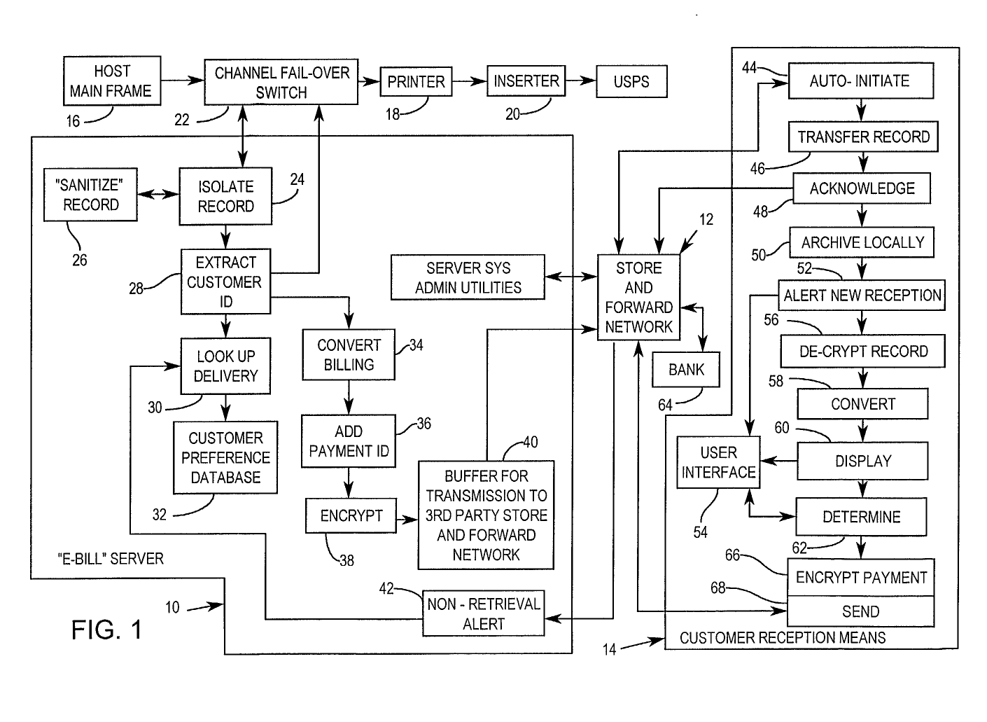

In describing the preferred embodiment of the instant invention, reference is made to the drawing, FIG. 1, which is both a block diagram showing the apparatus and a system flow chart describing the steps executed by the apparatus. The following description refers to billing records which is information that comprises a notice that payment to the sender (i.e. mailer) is required, i.e. a bill that may be sent from an entity, i.e. a mailer, to a customer either on occasion of a purchase, or periodically. Current practice is to imprint billing information on paper or other suitable substrate and send this imprinted information to a customer, typically via postal delivery means. As seen hereinbelow, the instant invention preserves this channel of communication while adding the capability to deliver the billing information electronically in addition to, or in place of, the physical delivery means.

Delivery of billing records to a customer via electronic means typically requires an electronic bill server depicted as subsystem 10, a communications network with store and forward capability depicted as 12, and a customer reception means depicted as subsystem 14. The store and forward capability in the communications network 12 is not technically necessary to implement the instant invention described herein, but has been included as part of the preferred embodiment to optimize communications between the electronic bill server 10 and the multitude of customer reception means 14.

Billing records typically are generated by the mailer's (i.e. billing party's) enterprise computing means, depicted as the host main frame computer 16. These billing records are typically communicated to a printing device 18, which prints the billing records on paper or other substrate, which is then conveyed to an inserter 20 which prepares and inserts bills and other documents into envelopes and affixes proper postage. The finished envelopes are then delivered to customers via a postal service, which in the United States is primarily the United States Postal Service.

The instant invention is achieved by tapping the communications channel between the mailer's main frame computer 16 and the printer 18 with an automatic selector switch 22 so that the billing record can be obtained while still in electronically readable form. The switch 22 routes the billing records to the bill server subsystem 10 for processing. In the event that the bill server subsystem 10 fails or is taken out of service deliberately, the selector switch 22 should have fail-over switching capability to preserve conventional communication to the printer 18.

Billing records enter the server 10 and are first processed at block 24 so that one customer's complete billing record is isolated from all the other customers' billing records. The isolated record can be passed through a sanitizing filter as indicated at block 26 which performs a number of convenient functions, such as verifying and/or correcting the accuracy of a customer's address, etc. Following sanitization at block 26, a unique customer identification (ID) must be extracted from the billing record as indicated at block 28. The customer ID is used as the index which enables looking up a delivery preference as indicated at block 30 in a customer preference database 32 which stores relevant information about the customers served by the server subsystem 10. Such relevant information may consist of, but is not limited to, the customer's: choice of delivery mode, i.e. paper or electronic, or both; choice of electronic channel, carrier and protocol, i.e. AOL, Advantis, Netcom, BBS, Internet; choice of financial institution(s) for payment transactions; and encryption keys(s) and status, used to secure the billing information transfer and any subsequent payment transfer. Based on the customer's ID, which is extracted at block 28, the customer's delivery preferences are extracted as indicated at block 30 from the database 32. Based on the customer's preferences, the billing record is routed to either the printer 18 for conventional mail preparation via the fail-over switch 22 or is converted to a generic format as indicated by block 34 in the case of electronic delivery. The converting step involves converting the customer's native record format (which may be different from mailer to mailer) to a standard, generic format for transfer to a plethora of customer reception means.

Based on information stored in the customer preference database 32, a particular customer, mailer and billing record are identified to a financial institution as indicated at block 36. Based again on information stored in the database 32, this enhanced, generic billing record can be encrypted for secure transmission to the customer as indicated at block 38. Depending on the specific communications network to be used, buffering may be required as indicated at block 40 to collect and hold one or more enhanced, generic billing records for subsequent transmission through the communications network 12. Transfer of enhanced, generic billing records to the communications network 12 may be executed either continuously or in batches.

The preferred embodiment assumes a relatively active approach by the end recipient (i.e. customer) of the billing records in that it is expected that the customer will periodically initiate communications with the communications network 12 by way of the customer reception means 14 to retrieve billing records stored therein. Thus, the network 12, in the preferred embodiment, possesses store and forward capability, since the customer is not likely to be retrieving bills exactly when the server 10 is sending them. The server 10 can even be configured to communicate with the communications network 12 at times of the day when network traffic is at a minimum, e.g. 3:00 a.m.

Thus, in the preferred embodiment, there is minimal need for a real time connection between the server 10 and the customer reception means 14. Such a real time connection would require the customer reception means 14 to be accessible to the communications network 12 on a continuous basis. Since, with current technology, the communications network 12 is likely to include the customer's telephone line, this accessibility would require a dedicated phone line for the customer reception means 14, which is obviously an undesirable expense for the customer. Thus, requiring the communications network 12 to be able to store the customer's billing record until the customer actively requests it eliminates the need for dedicated connection between the customer reception means 14 and the communications network 12.

An alternate method of delivery would have the communications network 12 automatically initiate communications with the customer reception means 14 at an off-peak time, e.g. 3:00 a.m., when the customer is least likely to be using its communications link to the network for other purposes. This automatically initiated connection may be via a silent or otherwise distinctive ring if the communications link to the customer reception means 14 is by way of telephone line.

As electronic communications technology evolves and communications network links proliferate, the customer reception means 14 may be connected and “on-line” with the communications network 12 continuously. In such a case, the store and forward capability in the network 12 may no longer be necessary.

As part of the communication between the communications network 12 and the server 10, the server 10 must interrogate the network 12 as to whether the previous billing record sent to a particular customer has as yet been retrieved by the customer. In the case that the previous billing record has not yet been retrieved, a notice of this situation will be logged within the server 10 as indicated at block 42. One or more occurrences of non-retrieval can be made to cause the current and even the non-retrieved, previous billing record(s) to be sent to the customer via traditional paper mail as a fall-back.

The customer reception means may be embodied in a variety of forms, such as a modem-equipped, personal computer, a network computer or terminal, an enhanced-function telephone, an enhanced-function telephone answering machine, an enhanced-function facsimile machine, an enhanced-function television, a personal communication device, a personal information assistant, or a device dedicated exclusively to the reception, storage and payment of electronic billing records, i.e. an electronic check book.

The customer reception means 14 must include a certain minimum number of functions, such as periodically initiating communications with the communications network 12 as indicated at block 44 and retrieving any billing records in waiting, as indicated at block 46. As part of the transfer process, the customer reception means 14 acknowledges back to the communications network 12 accurate transfer of the complete billing record as indicated at block 48. As part of the transfer process, the billing record is archived in non-volatile memory in/at the customer reception means 14, as indicated at block 50, for subsequent review by the customer. Examples of archival memory include, but are not limited to, non-volatile electronic memory technology such as NVRAM, “Flash” PROM, recordable CDROM, fixed disk, removable disk, human readable code on paper or other substrate, or machine readable code on paper or other substrate.

Subsequent to reception of the billing record, the customer reception means 14 should alert the customer, as indicated at block 52, via its user interface 54, that a new billing record has been retrieved and requires attention. The customer may then command the billing record to be presented for review. The customer may be required to provide via the user interface 54 an authorization code to cause the customer reception means 14 to de-crypt the billing record for viewing, as indicated at block 56. Following decryption, the billing record would then be converted from the generic billing record format common to all customer transmissions into the local format used by the particular customer reception means 14 to present and manipulate the billing information, as indicated at block 58. Examples of local format include, but are not limited to, Quicken, Microsoft Money, plain text, Magic Cap, check register, etc.

Following presentation of the billing record, the customer may choose to display and/or store or discard the billing record, as indicated at block 60, and effect payment, either manually by conventional means or automatically through the customer reception means 14. If the customer reception means 14 is utilized, it would present the payment due and allow the customer to determine the amount of payment to be made, as indicated at block 62, using the user interface 54. If a non-zero payment is chosen, a funds transfer is authorized using information from the financial institution 64, billing record information, payment amount information, encryption key(s) and customer identification provided by the server 10 and appended to the customer billing record, as indicated at block 66. This authorization is routed to the designated financial institution 64 (such as a bank) by way of the communications network 12, as indicated at block 66. Acknowledgment of this payment is sent back to the customer reception means 14 by way of the communications network 12 and processed in similar fashion to billing information by the customer reception means 14, as indicated at block 68.

While the present invention has been disclosed and described with reference to a single embodiment thereof, it will be apparent, as noted above that variations and modifications may be made therein. It is, thus, intended in the following claims to cover each variation and modification that falls within the true spirit and scope of the present invention.

What is claimed is:

1. An inserting system for communicating information from a mailer to a recipient by means of a document or electronic transmission, comprising:
means for generating said information located at a mailer's site;
an electronic information server operably connected to said information generating means for processing and routing said information;
a printer operably connected to said server for printing said information on a substrate;
an inserting system operably connected to said printer;
a communications network operably connected to said server for transmitting said information electronically; and
recipient reception means for receiving said information from said communications network, wherein said server routes said information to said recipient reception means or to said printer.

2. The system of claim 1, wherein said information server verifies the accuracy of said information.

3. The system of claim 2, wherein said information server determines whether or not the recipient has reviewed said transmitted information and provides contingent notification means if the recipient has not reviewed said transmitted information.

4. The system of claim 1, wherein said information comprises a bill.

5. The system of claim 4, additionally comprising means for electronically transferring funds from said recipient to said mailer.

6. The system of claim 4, wherein said information server identifies each bill uniquely.

7. The system of claim 6, wherein said reception means acknowledges accurate and complete reception of said bill to said information server.

8. The system of claim 7, wherein said information generating means comprises a computer.

9. The system of claim 8, wherein said communications network includes store and forward capability.

10. The system of claim 9, additionally comprising an automatic selector switch between said computer and said printer for routing said bills to said information server.

11. The system of claim 10, wherein said recipient reception means comprises a personal computer.
